(19) United States
(12) Patent Application Publication
(10) Pub. No.: US 2005/0055225 A1
(43) Pub. Date: Mar. 10, 2005

(54) Medical apparatus and method for generating a checklist

(76) Inventor: Reinhard Mehl, Neunkirchen am Brand (DE)

Correspondence Address: SIEMENS SCHWEIZ;I-44, INTELLECTUAL PROPERTY, ALBISRIEDERSTRASSE 245, ZURICH, CH-8047, CH

(21) Appl. No.: 10/655,010

(22) Filed: Sep. 5, 2003

(51) Int. Cl. G06F 17/60

(52) U.S. Cl. 705/1

(57) ABSTRACT

A medical apparatus comprises a processor unit which is configured to generate and display a checklist comprising a plurality of maintenance checks to be performed on the medical apparatus. The plurality of maintenance checks comprises only those maintenance checks which are necessary for the medical apparatus as currently configured. In addition, the checklist comprises a due date for each of said maintenance checks. When a maintenance check is completed, then the processing unit determines the next relevant due date. In a method for generating a checklist, a processing unit of a medical apparatus produces a checklist. The checklist comprises a plurality of maintenance checks to be performed on that medical apparatus and the plurality of maintenance checks comprises only those maintenance checks which are necessary for the medical apparatus as currently configured. The checklist is displayed on a display device.

### BACKGROUND OF THE INVENTION

The present invention relates to a medical apparatus and a method for generating a checklist used for carrying out a maintenance check on the medical apparatus.

Typically, medical apparatuses require periodic maintenance and checking so as to ensure safe and effective operation. Service and maintenance is generally performed by a service technician, who may travel to the site of the apparatus. Once present at the site, the technician follows a predefined checking scheme. In order to facilitate appropriate and required checking of the medical apparatus, the service technician has a checklist associated with the medical apparatus. The checklist details the checking scheme and comprises a sheet or several sheets of paper which include information about the individual checks to be performed. The checklist is normally designed in such a way that the service technician can check off an individual check-item on the checklist after the check-item has been completed. After completion of the checklist, the technician usually lets a person, who is responsible for the medical apparatus, sign the checklist for documentation purposes. Such a person may be an operator of the medical apparatus.

Particular medical apparatuses may be individually tailored or configured to the specific needs or requirements of the operator. Such medical apparatuses may include: magnetic resonance apparatus, X-ray apparatus, and computed tomography apparatus. The medical apparatus may further be equipped with optional and individual components. If the medical apparatus is a magnetic resonance apparatus, then such an optional component may be a special surface coil (see Erich Krestel (editor), “Imaging Systems For Medical Diagnostics”, Siemens Aktiengesellschaft, Berlin, Munich, 1988, pp.520-527). Typically, however, there is only a generic checklist designed for each type of medical apparatus to be checked, i.e. there may be a generic checklist for the magnetic resonance apparatus, for the X-ray apparatus, and for the computed tomography apparatus. In order to comprise every possible check to be performed on a specific medical apparatus, the checklist for a certain type of medical apparatus normally comprises information about each and every possible check which may or has to be carried out. As such, a checklist for a specific medical apparatus may include information about a check which is associated with a component of the medical apparatus, even though the particular medical apparatus in question lacks the component. In the case of the magnetic resonance apparatus, for instance, the checklist may include information about a check associated with the aforementioned surface coil even though the magnetic resonance apparatus does not have one.

In addition, completion of an entire checklist may be frustrated and delayed by an unexpected repair or other such hindrance. Accordingly, more than one visit by the technician may be required before the checklist is completed.

As a result, carrying out a check on a medical apparatus using a checklist according to the state of the art is cumbersome, inefficient and inconvenient.

### BRIEF SUMMARY OF THE INVENTION

It is an object of the present invention to provide a method and apparatus for enabling convenient, efficient and effective check ups and maintenance of medical apparatuses.

This and other objects of the present invention are effected by inclusion of an appropriately configured processor unit with a medical apparatus. The processor unit is configured and otherwise comprises means to generate and display a checklist, the checklist comprising a plurality of maintenance checks to be performed on the medical apparatus. The plurality of maintenance checks comprises only those maintenance checks which are necessary for the medical apparatus as currently configured. Furthermore, the checklist comprises a due date for each of the maintenance checks. The processor unit is further configured so as to determine the due date of the next maintenance check, when the corresponding maintenance check is completed.

As the checklist comprises only those maintenance checks which corresponds to the medical apparatus as configured, the service technician, or in general the person carrying out the maintenance service, does not receive nor have to work through and with unnecessary information. Such unnecessary information includes information related to a component with which the current medical apparatus is simply not equipped. Other such information may be related to configurations to which the medical apparatus are not configured. Likewise, the checklist may include information otherwise specific to the medical apparatus.

The checklist may include a date portion which displays the next due date for an associated maintenance check. The date in the date portion may be updated as necessary to keep current with the associated maintenance check. Accordingly, should the technician's work be interrupted, he/she is equipped with readily available information as to what has been done, what remains to be done, and what is in progress. As such, upon the technician's return to the medical apparatus, he/she does not need to perform unnecessary steps in order to determine where along the chain of maintenance he/she is. The list may further include a confirmation portion including indicia as to whether the associated check or task has been completed.

In another embodiment of the present invention, the processor unit is configured so as to produce a print-out of the checklist. With a printed checklist, the technician may obtain an authorizing signature upon completion of his/her work. The signed print-out may be used for documentation purpose. With this embodiment, a printer would be included with the processor, the printer being local or networked at a remote location.

In still another embodiment of the present invention, the processing unit is configured so as to automatically send a message to a computer over a communication network when at least one of the due dates is due. Determination of an “open” due date would include querying the confirmation portion. Based upon such messaging, a maintenance check can be conveniently scheduled.

The processing unit may also be configured to convey the checklist to a computer over a communication network. Particularly, if the checklist can be digitally signed, a completed check can easily be documented electronically and appropriately stored for future access.

In a yet another embodiment of the present invention, the checklist comprises a link to a description of how to perform a particular maintenance check of the plurality of maintenance checks. Data to which the link refers to may be locally stored or remotely stored and accessed via a network connection.

The above may be achieved with a method for generating a checklist, comprising the steps of: generating a checklist comprising a plurality of maintenance checks to be performed on a medical apparatus with a processing unit of that medical apparatus and displaying the checklist on a display device. In accordance with the invention, the plurality of maintenance checks comprises only maintenance checks which are necessary for the medical apparatus as currently configured.

The above may further be achieved by a medical apparatus, comprising: a processor unit for generating a checklist, said checklist comprising a list of necessary maintenance steps to be performed on said apparatus as said apparatus is currently configured, a confirmation portion for indicating a status of at least one of said maintenance steps, and a date portion for indicating a date relevant to said at least one of said maintenance steps, said processing unit comprising: means for generating said checklist, means for displaying said checklist, means for altering said checklist, and means for evaluating data associated with said confirmation portion and determining new data for said date portion upon select results of said evaluating.

The above may still further be achieved by a method for generating a checklist for apparatus maintenance, comprising the steps of: determining identity of said apparatus, said identity including apparatus configuration and components configured with said apparatus; determining maintenance steps associated with said identity; and generating a checklist comprising said maintenance steps.

### BRIEF DESCRIPTION OF THE SEVERAL VIEWS OF THE DRAWINGS

The novel features believed characteristic of the invention are set out in the claims below. The invention itself, however, as well as other features and advantages thereof, are best understood by reference to the detailed description, which follows, when read in conjunction with the accompanying drawings, wherein:

FIG. 1 depict a magnetic resonance apparatus,

FIGS. 2 and 3 depict a checklist generated by and for the magnetic resonance apparatus depicted in FIG. 1,

FIG. 4 depicts another magnetic resonance apparatus, and

FIG. 5 depicts a checklist generated by the magnetic resonance apparatus depicted in FIG. 4.

### DETAILED DESCRIPTION OF THE INVENTION

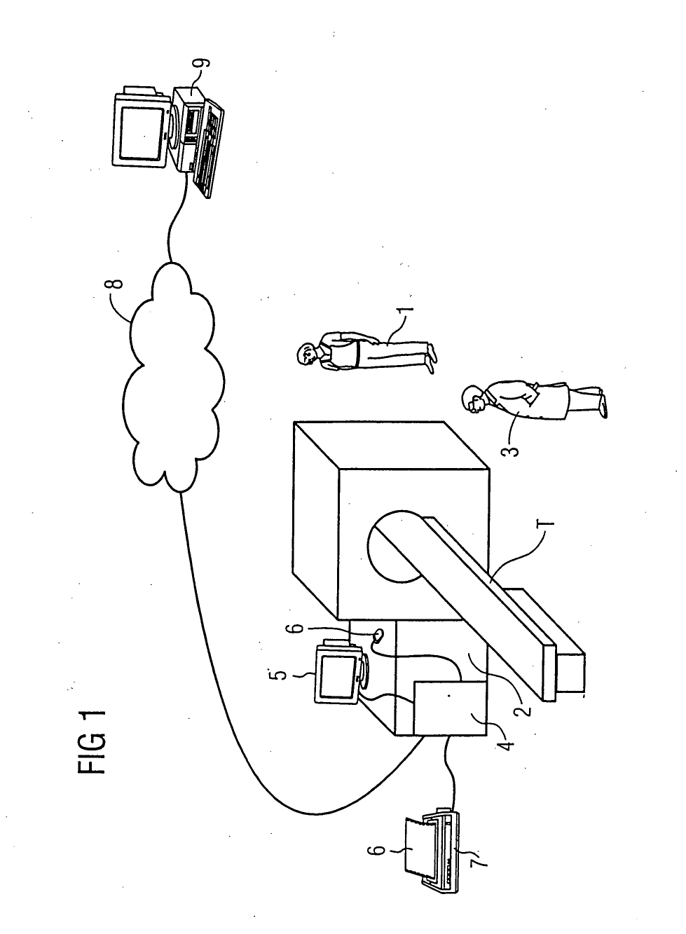

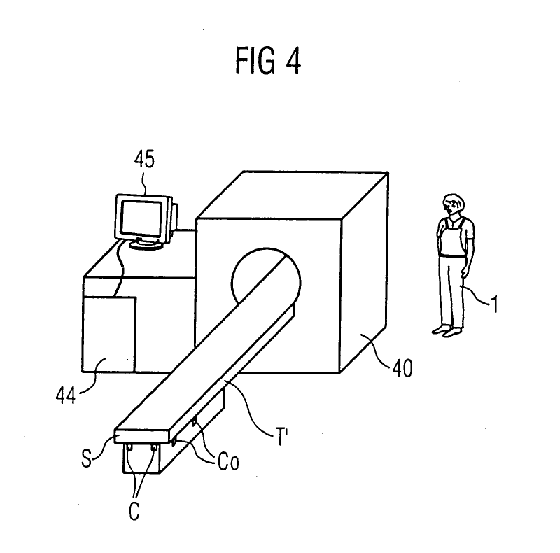

FIG. 1 depicts a technician 1 checking a magnetic resonance apparatus 2. The magnetic resonance apparatus 2 may be configured with several optional software and hardware components to fulfill individual requirements of its operator 3. For example, the magnetic resonance apparatus 2 may be equipped with a standard patient table T or with a more flexible patient table T. The more flexible patient table is designed so that its surface, on which the patient lies, can be changed. A magnetic resonance apparatus 40 configured with such a patient table T′ is depicted in FIG. 4, by way of example.

The magnetic resonance apparatus 2 has a processing unit 4 which controls the magnetic resonance apparatus 2 during operation as known in the art. In the present embodiment, the processing unit 4 is further configured with information about the current configuration of the magnetic resonance apparatus 2. In particular, the processing unit 4 is configured with information about optional software and hardware components with which the magnetic resonance apparatus 2 is currently configured.

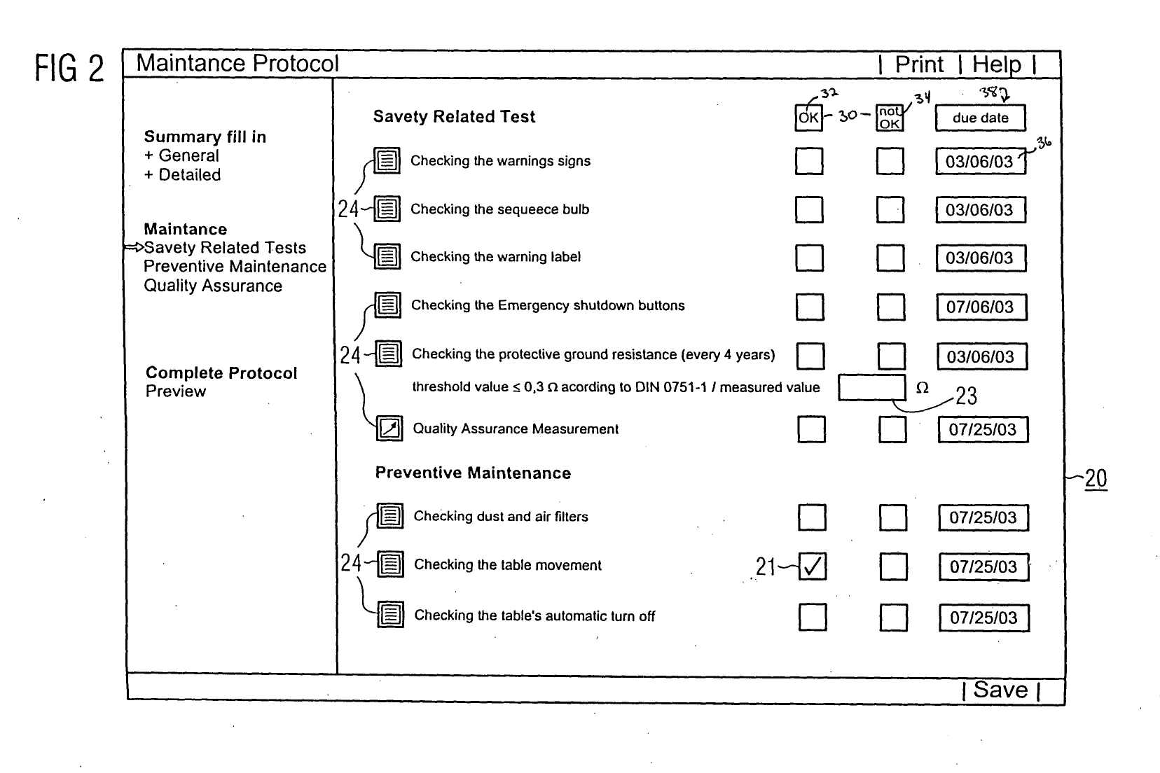

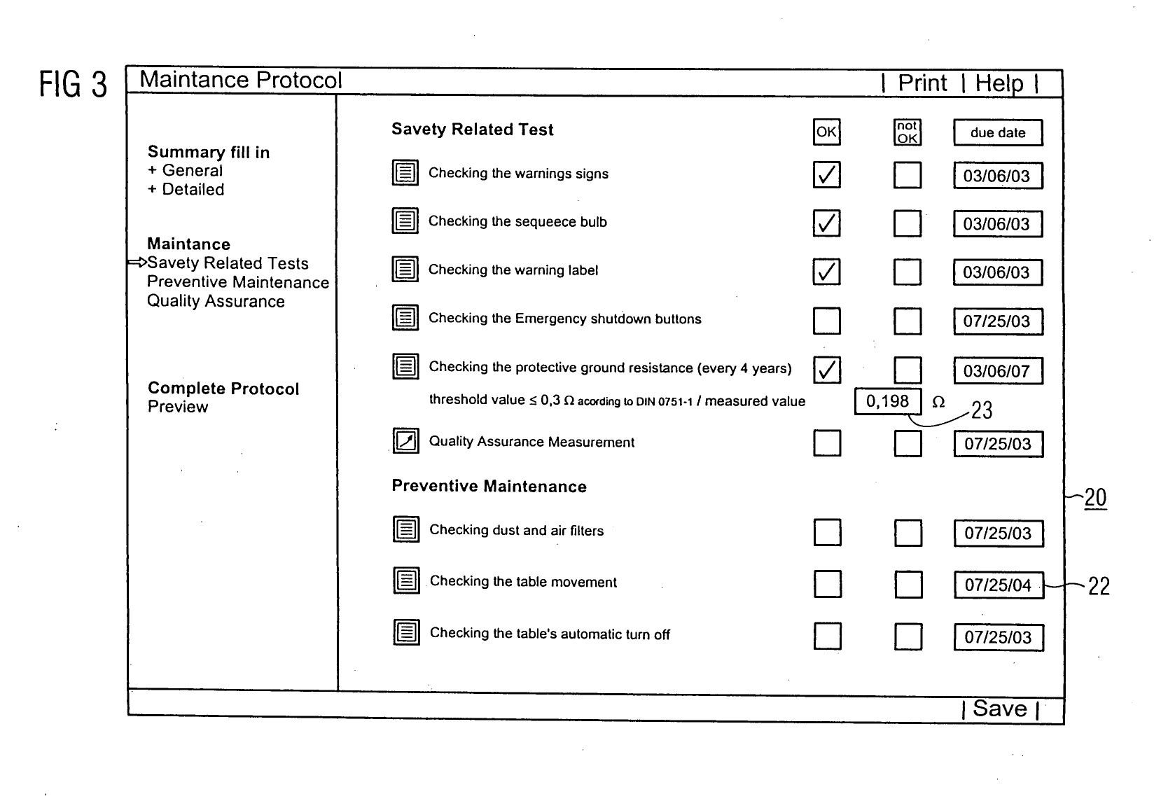

The processing unit 4 is further configured to and includes means to generate a checklist 20 which is depicted in FIGS. 2 and 3. The checklist 20 is meant for the technician 1 to support him/her carrying out a maintenance check on the magnetic resonance apparatus 2. The check list may be displayed on a screen 5 which is connected to the processing unit 4. The processing unit 4 generates the checklist 20 which comprises information about each single check required for the maintenance check on the magnetic resonance apparatus 2. The processing unit 4 further generates the checklist 20 in such a way so that it only comprises information about checks to be performed and does not comprise information about a check directed to a component with which the magnetic apparatus 2 is not currently configured. In the present example, the checklist 20, therefore, comprises information about a check associated with the standard patient table T and does not comprise information about a more flexible patient table such as the patient table T′ with which the magnetic resonance apparatus 40 depicted in FIG. 4 is equipped. By way of example, a task or check associated with the standard patient table T is to check if the table can still be easily moved.

Checklist 20 includes a confirmation portion 30 comprising information related to and about a due date of a particular check. When the technician 1 has completed an individual check, he/she reports it on the checklist 20. In particular, the technician reports if the component associated with the check is ok 32 or not ok 34. Depending upon the outcome, the appropriate field or box is ticked. The field or box comprises and active and inactive indicia. As displayed, this indicia comprises a check and an unchecked box. This ticking may be performed by clicking on an appropriate field on the checklist 20 with a mouse 6 operatively coupled to the processing unit 4. After an individual check is checked off indicating that the associate component or function of the magnetic resonance apparatus 2 is ok, the processing unit 4 determines the next due date of that check and updates the checklist 20 accordingly. Due dates are located in date fields or boxes 36 in date portion 38. The next due date may then be manually or automatically inserted into the date field 36. An automatic next due date determination may be effected by appropriate software operating on the processor. Other means of determination are also possible as would be envisioned by one skilled in the art. In the present embodiment, the technician 1 checks if the patient table T can be moved, i.e. determines whether patient table T is jammed. Assuming the patient table T to be ok, the technician checks off field 21 being associated with the individual check of the patient table T. After the technician has checked off field 21, the processing unit 4 determines the next due date for that individual check and updates the associated due date in field 22 as shown in FIG. 3.

If an individual check requires a measurement, then the technician 1 reports the measured value in an appropriate field of the checklist 20. In the present example, the technician 1 has to measure the ground resistance which, for effective operation, must be less than 0.3Ω. After measuring the ground resistance, the technician 1 reports the measured value in a measured value field 23 of checklist 20. After entering the measured value, the processing unit 4 checks if the entered value is less than 0.3. If the measured ground resistance is less than 0.3Ω, then the associated check is automatically checked off as depicted in FIG. 3. The automatic checking may be performed by means known to one skilled in the art.

For the technician's convenience, the checklist 20 may further comprise links to descriptions of individual checks. In order to activate such a link, the technician 1 has to click the appropriate field of the fields 24. After clicking, a description of the associated check appears on the screen 5.

When the technician 1 completed the entire maintenance check and all required checks are checked off on the checklist 20, then the processing unit 4 checks, if all required checks for a safe operation of the magnetic resonance apparatus 2 are marked “ok”. If all fields are marked “ok”, then the message “The maintenance check was successfully completed. The magnetic resonance apparatus 2 can safely be operated until the next maintenance check” appears on the screen 5. If at least one critical check is marked as “not ok”, then the message “The magnetic resonance apparatus 2 is in critical condition. Safe operation cannot be guaranteed” appears on the screen 5. These messages are not depicted in the figures for clarity purposes.

The processing unit 4 is in the present example configured to produce a print-out 6 of the checklist 20, when the maintenance check is completed. For the print-out, the checklist 20 is converted into a Portable Document Format “PDF” and is printed out with a printer 7 which is connected to the processing unit 4. In the present example, the print-out 6 is meant for being signed by the operator 3.

Alternatively, the PDF-file associated with the print-out 6 can be digitally signed, if the processing unit 4 is appropriately configured. An appropriate configuration is well known in the art and is thus not further described.

Particularly, if the PDF-file can be digitally signed, then it is advantageous, if, as it is shown in the present example, the processing unit 4 is connected to an information network 8, such as the Internet. Then, the PDF-file may be sent over the information network 8 to a computer 9 which is also connected to the same information network 8. The computer 9 may be specifically configured to store signed PDF-files which are associated with maintenance checks for documentation.

In addition, the processing unit 4 is in the present example configured to automatically send a message to the computer 9, when a maintenance check is due, in order to inform the technician 1 to schedule the maintenance check.

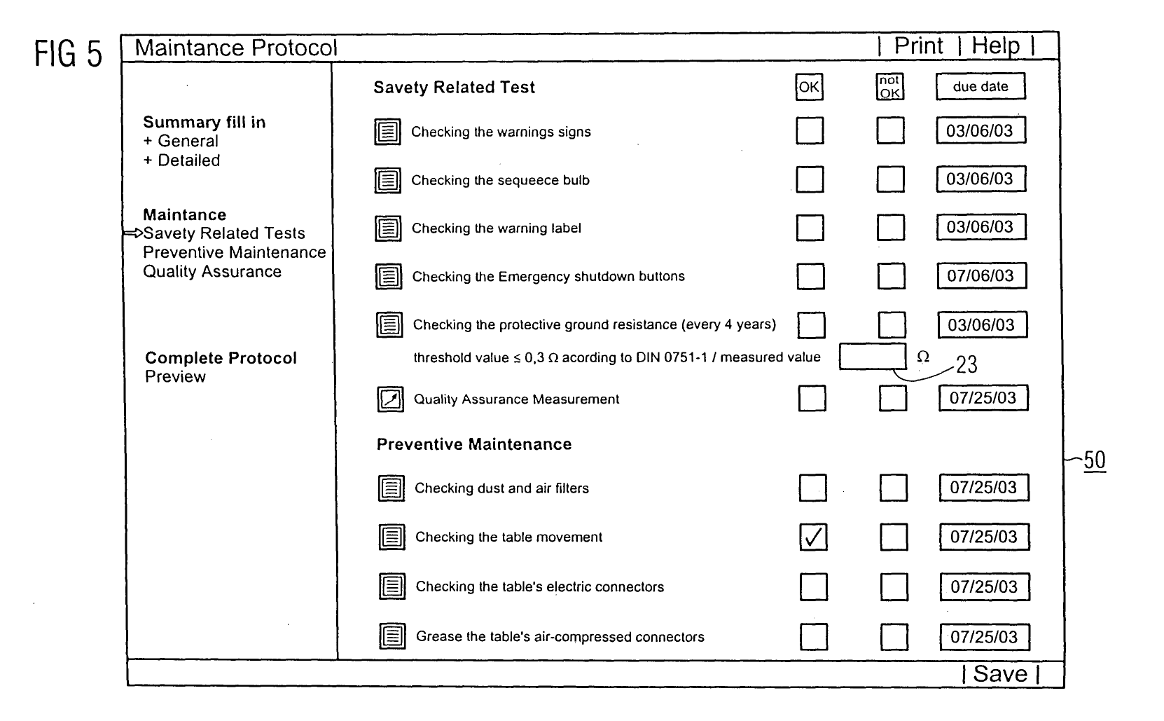

As indicated above, the magnetic resonance apparatus 40, depicted in FIG. 4, includes a more flexible patient table T′ (as compared with table T) whose surface S can be changed. During a maintenance check, electric contacts C of the patient table T′ have to be checked and compressed-air connectors CO of the patient table have to be greased. Thus, if the technician 1 conducts a maintenance check on the magnetic resonance apparatus 40, then a processing unit 44 of the magnetic resonance apparatus 40 generates a checklist 50 which is shown in FIG. 5 and is displayed on a screen 45 which is connected to the processing unit 54. Since the magnetic resonance apparatus 40 comprises the patient table T′, the checklist 50 has also an information about the check on the electric connectors C and an instruction on how to grease the air-compressed connectors CO.

Although modifications and changes may be suggested by those skilled in the art, it is the intention of the inventor to embody within the patent warranted hereon all changes and modifications as reasonably and properly come within the scope of his contribution to the art.

1. A medical apparatus, comprising:
a processor unit for generating a checklist, said checklist comprising a list of maintenance steps to be performed on said apparatus as said apparatus is currently configured, a confirmation portion for indicating a status of at least one of said maintenance steps, and a date portion for indicating a date relevant to said at least one of said maintenance steps, said processing unit comprising:
means for generating said checklist,
means for displaying said checklist,
means for altering said checklist, and
means for evaluating data associated with said confirmation portion and determining new data for said date portion upon select results of said evaluating.

2. The medical apparatus according to claim 1, wherein said date portion comprises date indicia indicating a due date of said at least one of said maintenance steps.

3. The medical apparatus according to claim 1, wherein said data associated with said confirmation portion comprises an active and inactive indicia.

4. The medical apparatus according to claim 1, wherein said processor unit further comprises means for generating a print-out of said checklist.

5. The medical apparatus according to claim 4, further comprising a printer functionally associated with said processor unit so as to effect a print out said checklist.

6. The medical apparatus according to claim 5, wherein said printer is one of a local printer and a remote printer.

7. The medical apparatus according to claim 1, wherein said processing unit further comprises means for sending a message to a remote computer, over a communication network, when at least one of said due dates comes due.

8. The medical apparatus according to claim 1, wherein said processing unit further comprises means for sending said checklist to a computer over a communication network.

9. The medical apparatus according to claim 1, wherein said checklist further comprises a link to a description of how to perform a maintenance step of said plurality of maintenance steps.

10. The medical apparatus according to claim 1, wherein said checklist comprises a measured value field for insertion of measure value date associated with said apparatus.

11. A method for generating a checklist for apparatus maintenance, comprising the steps of:
determining identity of said apparatus, said identity including apparatus configuration and components configured with said apparatus;
determining maintenance steps associated with said identity; and
generating a checklist comprising said maintenance steps.

12. The method according to claim 11, further comprising the step of displaying said checklist.

13. The method according to claim 12, wherein said checklist is displayed on one of a local and remote display apparatus.

14. The method according to claim 11, further comprising the step of printing said checklist.

15. The method according to claim 14, wherein said checklist is printed on one of a local and remote printer.

16. The method according to claim 11, further comprising the step of sending said checklist via a communications network to a remote computer.

17. The method according to claim 11, wherein said steps of determining identity, determining maintenance steps and generating a checklist, are performed by a processor functionally associated with said apparatus.

18. The method according to claim 11, wherein said apparatus is a medical apparatus.

19. The method according to claim 11, wherein said checklist further comprises at least one date data field associated with at least one of said maintenance steps, said at least one date data field comprising a date indicia.

20. The method of claim 19, further comprising the steps of:
determining if said maintenance check has been successfully completed,
upon successful completion, determining when a next maintenance check is to be performed, and
changing date indicia to indicate a date for said next maintenance check.

21. The method according to claim 20, wherein said checklist further comprises at least one confirmation field associated with at least one of said maintenance steps, said confirmation field comprising indicia indicating a completed step.

22. The method according to claim 21, wherein said step of determining if said maintenance check has been successfully completed further comprises the step of querying said confirmation field for an indication of completed maintenance step.

23. The method according to claim 19, further comprising the steps of:
determining if said date indicia comprises a date which has come due, and
upon determination of said date coming due, generating an electronic message indicating that said date indicia has come due, and
sending said message over a communication network to a remote computer.

24. The method according to claim 21, wherein said checklist further comprises a measured value field for receiving data associated with a measured value of said apparatus, said measured value field being associated with at least one maintenance step.

25. The method according to claim 24, further comprising the steps of:
determining if said measured value falls within a predefined value range, said value range associated with said apparatus, and
upon determination that said measured value falls within said value range, indicating a completed maintenance step in a confirmation field associated with said at least one maintenance step.
